(19) United States
(12) Patent Application Publication
(10) Pub. No.: US 2009/0130340 A1
(43) Pub. Date: May 21, 2009

(54) LIGHT DIFFUSION PLATE AND BACKLIGHT MODULE USING THE SAME

(75) Inventor: SHAO-HAN CHANG, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/963,875

(22) Filed: Dec. 24, 2007

(30) Foreign Application Priority Data
Nov. 15, 2007 (CN) 200710202543.1

(51) Int. Cl. C09K 19/00

(52) U.S. Cl. 428/1.1

(57) ABSTRACT

A light diffusion plate according to a preferred embodiment includes a transparent substrate and a light diffusion layer formed on a surface of the transparent substrate. The light diffusion layer includes a transparent resin matrix, a plurality of first particles, and a plurality of second particles. The first particles and the second particles are dispersed in the transparent resin matrix. A diameter of each first particle is in a range from 5 microns to 60 microns. A diameter of each second particle is less than 0.5 microns. A backlight module using the present light diffusion plate is also provided.

### BACKGROUND OF THE INVENTION

1. Field of the Invention

The present invention relates to light diffusion plates, particularly, to a light diffusion plate used in a backlight module.

2. Discussion of the Related Art

In a liquid crystal display device, liquid crystal is a substance that does not itself radiate light. Instead, the liquid crystal relies on light received from a light source to display images. In the case of a typical liquid crystal display device, a backlight module powered by electricity supplies the needed light.

FIG. 3 represents a typical direct type backlight module 100. The backlight module 100 includes a light diffusion plate 10, a frame 11, a plurality of lamps 12, a light diffusion sheet 13, and a prism sheet 14. The light diffusion plate 10, the light diffusion sheet 13, and the prism sheet 14 are stacked above a top of the frame 11 in that order. The lamps 12 are positioned in the frame 11 under the light diffusion plate 10. The light diffusion plate 10 includes a plurality of dispersion particles (not labeled) therein. The dispersion particles are configured for scattering light, thus enhancing the uniformity of light exiting the light diffusion plate 10. The light diffusion sheet 13 includes a transparent base 131 and an ink layer 132 formed on the transparent base 131. The ink layer 132 contains a plurality of beads (not labeled). The prism sheet 14 has a plurality of V-shaped structures 141. The V-shaped structures 141 are configured for collimating light exiting from the prism sheet 14.

In use, light from the lamps 12 are substantially diffused in the light diffusion plate 10 and the light diffusion sheet 13, and finally surface light is outputted from the prism sheet 14.

In the above mentioned backlight module 100, the light diffusion plate 10 and the light diffusion sheet 13 are all configured for diffusing light. However, when the light diffusion plate 10 and the light diffusion sheet 13 are used in the same backlight module 100, a boundary exists between the light diffusion plate 10 and the light diffusion sheet 13. As a result, a plurality of air pockets may be found at the boundary. When the backlight module 100 is in use, light passes through the air pockets, and some of the light undergoes total reflection at one or another of the corresponding boundaries. Thus the light energy utilization ratio of the backlight module 100 is reduced.

What is needed, therefore, is a new light diffusion plate and a backlight module using the light diffusion plate that can overcome the above-mentioned shortcomings.

### SUMMARY

A light diffusion plate according to a preferred embodiment includes a transparent substrate and a light diffusion layer formed on a surface of the transparent substrate. The light diffusion layer includes a transparent resin matrix, a plurality of first particles, and a plurality of second particles. The first particles and the second particles are dispersed in the transparent resin matrix. A diameter of each first particle is in a range from 5 microns to 60 microns. A diameter of each second particle is less than 0.5 microns.

A backlight module includes a frame, a plurality of light sources, a light diffusion plate described in the previous paragraph, and a prism sheet. The light sources are positioned in the frame. The light diffusion plate is positioned on a top of the frame above the light sources. The prism sheet is positioned above the light diffusion plate in a way such that the light diffusion layer is adjacent to the prism sheet, and the transparent substrate is away from the prism sheet.

Other advantages and novel features will become more apparent from the following detailed description of various embodiments, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present light diffusion plate and backlight module. Moreover, in the drawings, like reference numerals designate corresponding parts throughout the several views, and all the views are schematic.

FIG. 1 is an exploded, side cross-sectional view of a backlight module using a light diffusion plate according to a first preferred embodiment of the present invention.

FIG. 2 is a side cross-sectional view of a light diffusion plate according to a second preferred embodiment of the present invention.

FIG. 3 is an exploded, side cross-sectional view of a conventional backlight module.

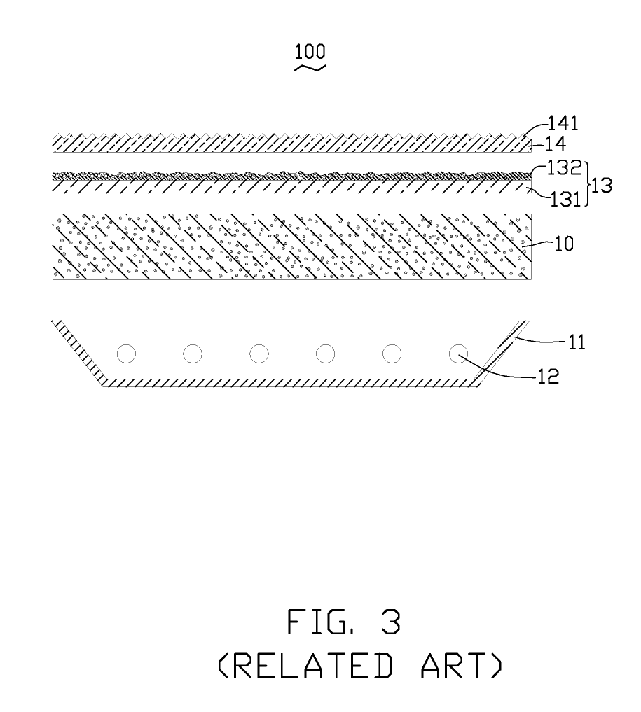

### DETAILED DESCRIPTION OF THE PREFERRED EMBODIMENTS

Reference will now be made to the drawings to describe preferred embodiments of the present light diffusion plate and backlight module, in detail.

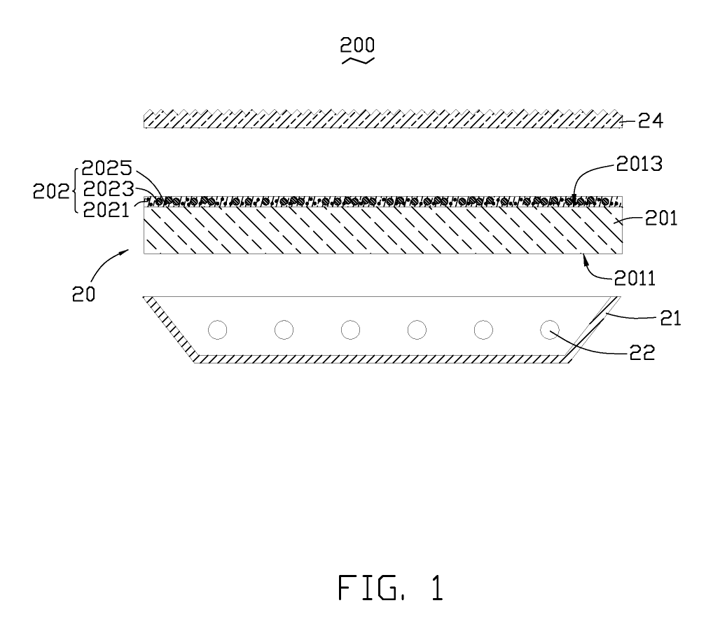

Referring to FIG. 1, a backlight module 200 in accordance with a first preferred embodiment is shown. The backlight module 200 includes a light diffusion plate 20, a frame 21, a plurality of lamps 22, and a prism sheet 24. The light diffusion plate 20 and the prism sheet 24 are positioned on a top of the frame 21. The lamps 22 are positioned in the frame 21 under the light diffusion plate 20.

The light diffusion plate 20 includes a transparent substrate 201 and a light diffusion layer 202. The transparent substrate 201 includes a light input surface 2011 and a top interface 2013. The light input surface 2011 and the top interface 2013 are on opposite sides of the transparent substrate 201. The light diffusion layer 202 is formed on the top interface 2013. In this embodiment, the prism sheet 24 is stacked on the light diffusion plate 20 in a way such that the light diffusion layer 202 is adjacent to the prism sheet 24, and the transparent substrate 201 is away from the prism sheet 24. A thickness of the light diffusion plate 20 is in a range from 1 millimeter to 3 millimeters.

The transparent substrate 201 can be made from material selected from the group consisting of polycarbonate (PC), polymethyl methacrylate (PMMA), polystyrene (PS), copolymer of methylmethacrylate and styrene (MS), and any suitable combination thereof.

A thickness of the light diffusion layer 202 is in a range from 5 microns to 100 microns. The light diffusion layer 202 includes a transparent resin matrix 2021, a plurality of first particles 2023, and a plurality of second particles 2025. The first particles 2023 and the second particles 2025 are uniformly dispersed in the transparent resin matrix 2021.

The transparent resin matrix 2021 can be made from material selected from the group consisting of polymethyl methacrylate (PMMA), epoxy, and combination thereof. A weight ratio of the transparent resin matrix 2021 to the light diffusion layer 202 is in a range from about 15% to about 80%.

A diameter of each first particle 2023 is in a range from 5 microns to 60 microns. The first particles 2023 can be made of acrylic resins. A weight ratio of the first particles 2023 to the light diffusion layer 202 is in a range from about 20% to about 85%.

A diameter of each second particle 2025 is less than 0.5 microns. The second particles 2025 can be made of titanium dioxide. A weight ratio of the first particles 2023 to the light diffusion layer 202 is less than 1%. A refractive index of the second particles is in a range from 2 to 3.

The lamps 22 are cold cathode fluorescent lamps. In an alternative embodiment, the lamps 22 can be replaced by other light sources, such as light emitting diode (LED).

Because a diameter of each first particle 2023 is in a range from 5 microns to 60 microns, the first particles 2023 acts like conventional dispersion particles in a conventional diffusion sheet, light is partially reflected and refracted by the first particles 2023. Moreover, because a diameter of each second particle 2025 is less than 0.5 microns, the second particles 2025 acts like particles in a conventional diffusion plate, light is partially reflected and diffracted by the second particles 2025. Thus the light diffusion layer 202 has a good light diffusion capability with the combined effects of the first particles 2023 and the second particles 2025. Therefore, the light diffusion plate 20 may replace a light diffusion plate and a light diffusion sheet that are ordinarily used in a backlight module. Therefore, air pockets that would ordinarily exist in the backlight module are eliminated, and loss of light energy in the backlight module is reduced. In addition, because the single light diffusion plate 20 can substitute a combination of conventional light diffusion plate and a light diffusion sheet, the cost of the backlight module is also reduced.

Futhermore, light is partially refracted by the first particles 2023, thus the light refracted by the first particles 2023 improve an illumination of the backlight 200 within a view angle.

When the lamps 22 are powered-on, a significant amount of undesired ultraviolet light are unavoidably produced. Because the transparent substrate 201 of the light diffusion plate 20 is formed of transparent synthetic resin material, the transparent substrate 201 easily changes color and/or expands due to a long-term irradiation of the ultraviolet rays. Thus, problems such as poor optical uniformity, poor brightness, and worsening optical performance of the backlight module 200, occurs.

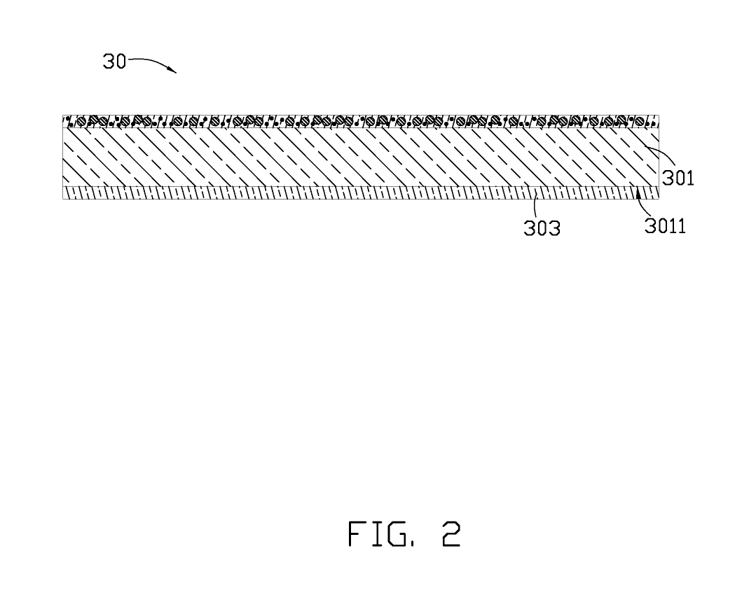

In order to solve these potential problems, referring to FIG. 2 a light diffusion plate 30 in accordance with a second preferred embodiment is provided. The light diffusion plate 30 is similar in principle to the light diffusion plate 20 of the first embodiment, except that the light diffusion plate 30 further includes a protective layer 303 formed on a light input surface 3011 of a transparent substrate 301.

The protective layer 303 includes a transparent resin matrix material and a plurality of fluorescent particles (not shown) uniformly dispersed in the transparent resin matrix material. When ultraviolet light from the lamps hits the fluorescent particles, a significant amount of the ultraviolet rays transforms into visible light. Therefore, the light energy of utilization rate of the backlight module 200 is increased. Moreover, the ultraviolet light will not reach the transparent substrate 301 due to the protective layer 303, discoloration of the transparent substrate 301 is eliminated or reduced.

Finally, while various embodiments have been described and illustrated, the invention is not to be construed as being limited thereto. Various modifications can be made to the embodiments by those skilled in the art without departing from the true spirit and scope of the invention as defined by the appended claims.

What is claimed is:

1. A light diffusion plate comprising:
a transparent substrate having a surface, and a light diffusion layer formed on the surface of the transparent substrate, the light diffusion layer comprising a transparent resin matrix, a plurality of first particles, and a plurality of second particles, the first particles and the second particles dispersed in the transparent resin matrix, wherein a diameter of each first particle is in a range from 5 microns to 60 microns, and a diameter of each second particle is less than 0.5 microns.

2. The light diffusion plate according to claim 1, wherein a refractive index of the second particles is in a range from 2 to 3.

3. The light diffusion plate according to claim 1, wherein a weight ratio of the first particles to the light diffusion layer is less than 1%.

4. The light diffusion plate according to claim 1, wherein the second particles are made of titanium dioxide.

5. The light diffusion plate according to claim 1, wherein a weight ratio of the first particles to the light diffusion layer is in a range from about 20% to about 85%.

6. The light diffusion plate according to claim 1, wherein the first particles are made of polymethyl methacrylate.

7. The light diffusion plate according to claim 1, wherein a weight ratio of the transparent resin matrix to the light diffusion layer is in a range from about 15% to about 80%.

8. The light diffusion plate according to claim 1, wherein the transparent resin matrix is made from material selected from the group consisting of polymethyl methacrylate, epoxy, and combination thereof.

9. The light diffusion plate according to claim 1, further comprising a protective layer formed on a surface of the transparent substrate.

10. The light diffusion plate according to claim 9, wherein the protective layer comprises a transparent resin matrix material and a plurality of fluorescent particles dispersed in the transparent resin matrix material.

11. A backlight module comprising:
a frame;
a plurality of light sources positioned in the frame:
a light diffusion plate positioned on a top of the frame above the light sources, the light diffusion plate comprising:
a transparent substrate having a surface, and
a light diffusion layer formed on the surface of the transparent substrate, the light diffusion layer comprising a transparent resin matrix, a plurality of first particles, and a plurality of second particles, the first particles and the second particles dispersed in the transparent resin matrix, wherein a diameter of each first particle is in a range from 5 microns to 60 microns, and a diameter of each second particle is less than 0.5 microns; and
a prism sheet positioned above the light diffusion plate in a way such that the light diffusion layer is adjacent to the prism sheet, and the transparent substrate is away from the prism sheet.

12. The backlight module according to claim 11, wherein a refractive index of the second particles is in a range from 2 to 3.

13. The backlight module according to claim 11, wherein a weight ratio of the first particles to the light diffusion layer is less than 1%.

14. The backlight module according to claim 11, wherein the second particles are made of titanium dioxide.

15. The backlight module according to claim 11, wherein a weight ratio of the first particles to the light diffusion layer is in a range from about 20% to about 85%.

16. The backlight module according to claim 11, wherein the first particles are made of polymethyl methacrylate.

17. The backlight module according to claim 1, wherein a weight ratio of the transparent resin matrix to the light diffusion layer is in a range from about 15% to about 80%.

18. The backlight module according to claim 11, further comprising a protective layer formed on a surface of the transparent substrate.

19. The backlight module according to claim 18, wherein the protective layer comprises a transparent resin matrix material and a plurality of fluorescent particles dispersed in the transparent resin matrix material.
